(19) United States
(12) Patent Application Publication
(10) Pub. No.: US 2021/0378076 A1
(43) Pub. Date: Dec. 2, 2021

(54) CREATING A COMBINED IMAGE BY SEQUENTIALLY TURNING ON LIGHT SOURCES

(71) Applicant: SIGNIFY HOLDING B.V., EINDHOVEN (NL)

(72) Inventors: TOBIAS BORRA, RIJSWIJK (NL); DZMITRY VIKTOROVICH ALIAKSEYEU, EINDHOVEN (NL); MARCUS THEODORUS MARIA LAMBOOIJ, EINDHOVEN (NL)

(21) Appl. No.: 17/282,538

(22) PCT Filed: Sep. 30, 2019
(86) PCT No.: PCT/EP2019/076383

§ 371 Date: Apr. 2, 2021

(30) Foreign Application Priority Data
Oct. 4, 2018 (EP) 18198685.2

(51) Int. Cl. H05B 47/155; H04N 5/265; G06F 3/0482; G06F 3/0485; G06F 3/0484; G06T 7/90; H04N 9/77

(52) U.S. Cl. CPC H05B 47/155; H04N 5/265; G06F 3/0482; G06F 3/0485; G06F 3/04845; G06T 2207/20212; H04N 9/77; G06T 2207/10152; G06T 2207/10024; G06T 2200/24; G06T 7/90

(57) ABSTRACT

A system is configured to sequentially turn on each of a plurality of sets (13-15) of one or more light sources and capture an image (53) of a spatial area comprising the plurality of sets of one or more light sources. Each of the images captures a similar or same spatial area and comprises only one (15) of the plurality of sets of one or more light sources in a turned-on state. The system is further configured to combine the images into a combined image. The combined image comprises each of the plurality of sets of one or more light sources in a turned-on state.

### FIELD OF THE INVENTION

The invention relates to a system for capturing images.

The invention further relates to a method of capturing images.

The invention also relates to a computer program product enabling a computer system to perform such a method.

### BACKGROUND OF THE INVENTION

One of the main benefits of having a dynamic lighting system is to be able to exactly tune the system. With the color gamut of the Philips Hue lamps, a myriad of possibilities exists to be able to exactly tune the lights as the user would want. With a Philips Hue system and the accompanying Philips Hue app, users are able to fine-tune each light to the exact color point they want. However, with millions of colors available per lamp, this can become quite overwhelming. From user feedback and data gathered, it seems that a lot of people only use either the default settings (e.g. only warm white), or only a few preset scenes.

US20170251538A discloses a method for automatically mapping light elements in light structures arranged in an assembly. The methods includes defining a sequence of test frames each specifying activation of a unique subset of light elements in the assembly executable by the set of light structures; serving the sequence of test frames to the assembly for execution; receiving photographic test images of the assembly, each photographic test image recorded during execution of one test frame by the assembly; for each photographic test image, identifying a location of a particular light element based on a local change in light level represented in the photographic test image, the particular light element activated by the set of light structures according to a test frame during recordation of the photographic test image; and aggregating locations of light elements identified in photographic test images into a virtual map representing positions of light elements within the assembly.

Instead of expecting users to be light designers, an ideal app would assist the user in this process. US 2018/0075626A1 discloses a method of controlling a lighting system which comprises outputting a displayed image to a user on a screen of a user interface, allowing the user to select a region from amongst a plurality of regions in the displayed image each having a respective color, and controlling one or more of the luminaires of the lighting system to emit illumination rendering the color of the region selected by the user from the displayed image.

A drawback of this method is that the user does not know what exactly the selected color(s) will look like in practice, i.e. on the specific luminaires to be controlled. As a result, it will take trial and error for the user to find the desired color(s) for his specific luminaires.

### SUMMARY OF THE INVENTION

It is a first object of the invention to provide a system, which reduces or avoids a user's reliance on trial and error for selecting settings for one or more light sources.

It is a second object of the invention to provide a method, which reduces or avoids a user's reliance on trial and error for selecting settings for one or more light sources.

In a first aspect of the invention, a system for capturing images comprises at least one processor configured to sequentially turn on each of a plurality of sets of one or more light sources and capture an image of a spatial area comprising said plurality of sets of one or more light sources, each of said images capturing a similar or same spatial area and comprising only one of said plurality of sets of one or more light sources in a turned-on state, and combine said images into a combined image, said combined image comprising each of said plurality of sets of one or more light sources in a turned-on state. The system may be a lighting system, may be part of a lighting system or may be used in a lighting system.

By capturing images of each set of one or more light sources separately and then combining them into a combined image, a faithful photograph or rendering of a user's light system with any desired light source setting can be obtained, thereby overcoming artefacts that regularly arise when taking pictures of lighting systems. With this faithful photograph or rendering, the system is able to show what certain settings would look like on light sources without the user having to try out these certain setting on these light sources themselves, amongst others.

Said at least one processor may be configured to combine said images into a plurality of combined images, at least one of said sets of one or more light sources having a different color in a first one of said plurality of combined images compared to a second one of said plurality of combined images (which results in different combined images), and allow a user to scroll through said plurality of (different) combined images and select one of said plurality of (different) combined images. This allows the user to choose from a plurality of different configurations that the user might be interested in and takes the user relatively little effort to select light source colors.

Said at least one processor may be configured to allow a user to adapt said combined image by manually recoloring one or more of said plurality of sets of one or more light sources in said combined image and render said adapted combined image. This allows the user to specify exactly which light source color(s) he is interested in and see the results in an image.

Said at least one processor may be configured to allow a user to select a further image, extract a color palette from said further image, adapt said combined image by automatically recoloring one or more of said plurality of sets of one or more light sources in said combined image based on said determined color palette and render said adapted combined image. This allows the user to provide an indication of what light source color(s) he desires without having to specify the exact light source colors.

Said at least one processor may be configured to combine said images by including at least part of each of said images in one of a plurality of layers of said combined image and assembling said plurality of layers, said part of said image comprising a set of one or more light sources in a turned-on state. This makes it simpler to create a combined image for different light source settings.

Said at least one processor may be configured to allow a user to adjust each of said plurality of layers in brightness and/or chromaticity before assembling said plurality of layers. This allows the user to specify exactly which light source color(s) he is interested in and see the results in an image.

Said at least one processor may be configured to identify pixels with a maximum color value, e.g. a maximum value in at least one of the RGB color channels, in said images or in said combined image. Said at least one processor may be configured to replace said color value of said identified pixels with another color value. This makes the photograph or rendering of the user's light system more faithful by adjusting clipped pixels.

Said at least one processor may be configured to change the setting of the at least one of said sets of one or more light sources having a different color in a first one of said plurality of combined images compared to a second one of said plurality of combined images, to said different color. In this way the setting of the light sources is changed to the preferences of a user.

In a second aspect of the invention, a method of capturing images comprises sequentially turning on each of a plurality of sets of one or more light sources and capturing an image of a spatial area comprising said plurality of sets of one or more light sources, each of said images capturing a similar or same spatial area and comprising only one of said plurality of sets of one or more light sources in a turned-on state, and combining said images into a combined image, said combined image comprising each of said plurality of sets of one or more light sources in a turned-on state. Said method may be performed by software running on a programmable device. This software may be provided as a computer program product.

Combining said images may comprise combining said images into a plurality of combined images, at least one of said sets of one or more light sources having a different color in a first one of said plurality of combined images compared to a second one of said plurality of combined images, and said method may further comprise allowing a user to scroll through said plurality of combined images and select one of said plurality of combined images.

Said method may further comprise allowing a user to adapt said combined image by manually recoloring one or more of said plurality of sets of one or more light sources in said combined image and rendering said adapted combined image.

Said method may further comprise allowing a user to select a further image, extracting a color palette from said further image, adapting said combined image by automatically recoloring one or more of said plurality of sets of one or more light sources in said combined image based on said determined color palette and rendering said adapted combined image.

Said method may further comprise changing the setting of the at least one of said sets of one or more light sources having a different color in a first one of said plurality of combined images compared to a second one of said plurality of combined images, to said different color.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores a software code portion, the software code portion, when executed or processed by a computer, being configured to perform executable operations comprising: sequentially turning on each of a plurality of sets of one or more light sources and capturing an image of a spatial area comprising said plurality of sets of one or more light sources, each of said images capturing a similar or same spatial area and comprising only one of said plurality of sets of one or more light sources in a turned-on state, and combining said images into a combined image, said combined image comprising each of said plurality of sets of one or more light sources in a turned-on state.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like, conventional procedural programming languages, such as the “C” programming language or similar programming languages, and functional programming languages such as Scala, Haskell or the like. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of an embodiment of the system;

FIG. 2 is a flow diagram of a first embodiment of the method;

FIG. 3 is a flow diagram of a second embodiment of the method;

FIG. 4 is a flow diagram of a third embodiment of the method;

FIG. 5 depicts a room with the three light sources of FIG. 1;

FIG. 6 is an example of an image of the room of FIG. 5 captured with the first light source turned on;

FIG. 7 is an example of an image of the room of FIG. 5 captured with the second light source turned on;

FIG. 8 is an example of an image of the room of FIG. 5 captured with the third light source turned on;

FIG. 9 is an example of a combination of the images of FIGS. 6-8; and

FIG. 10 is a block diagram of an exemplary data processing system for performing the method of the invention.

Corresponding elements in the drawings are denoted by the same reference numeral.

### DETAILED DESCRIPTION OF THE EMBODIMENTS

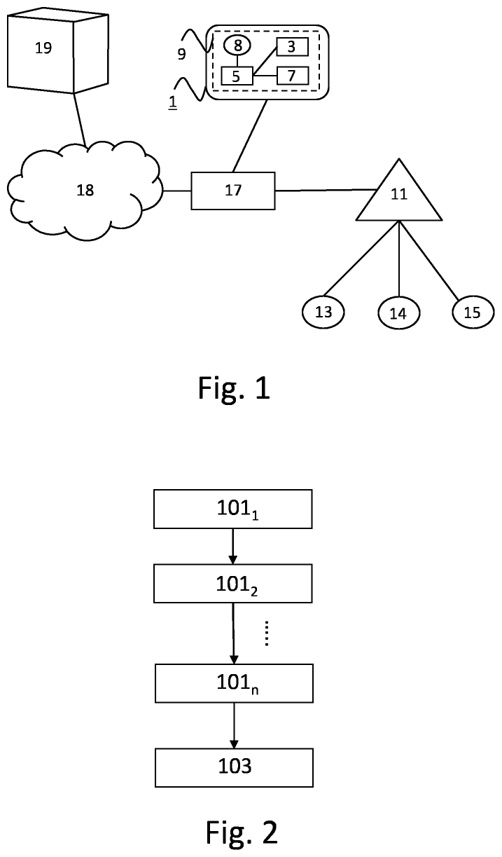

FIG. 1 shows an embodiment of the system of the invention: mobile device 1. Mobile device 1 is connected to a wireless LAN access point 17. A bridge 11 is also connected to the wireless LAN access point 17, e.g. via Ethernet. Light devices 13, 14 and 15 communicate wirelessly with the bridge 11, e.g. using the Zigbee protocol, and can be controlled via the bridge 11, e.g. by the mobile device 1. The bridge 11 may be a Philips Hue bridge and the light devices 13-15 may be Philips Hue lights, for example. In an alternative embodiment, light devices are controlled without a bridge. The wireless LAN access point 17 is connected to the Internet 18. An Internet server 19 is also connected to the Internet 18. The mobile device 1 may be a mobile phone or a tablet, for example.

The mobile device 1 comprises a processor 5, a transceiver 3, a memory 7, a camera 8, and a display 9. The processor 5 is configured to sequentially turn on each of the lights sources 13-15 and use camera 8 to capture an image of a spatial area comprising the light sources 13-15. Each of the images captures a similar or same spatial area and comprises only one of the light sources 13-15 in a turned-on state.

The processor 5 is further configured to combine the images into a combined image. The combined image comprises each of the light sources 13-15 in a turned-on state. In the embodiment of FIG. 1, a single light source is turned on before capturing an image. In an alternative embodiment, multiple light sources are turned before capturing at least one of the images. This is beneficial, for example, if these multiple light sources typically have the same color value. Thus, a set of light sources is turned on before capturing each image and this set comprises one or more light sources.

The resulting data will comprise information per light source, with respect to the position in the room and reflectance patterns of the light sources (e.g. on the ceiling, walls, furniture etc.). When this information is combined for all available light sources individually, a faithful representation of their combined effect can be created. This combination can then be optimized such that artifacts like clipping of the light sources (which can result in the loss of chromatic information) will be reduced.

Additionally or alternatively, the user may be allowed to recolor the lights in his system. Even though the effect of this recoloring will be more or less identical to actually setting the lights in the system to different color points (i.e. not virtually), it will assist the user in setting the system to their preference without trial-and-error. The user may, for example, be able to recolor the lights by:

1. rapidly scrolling through a series of (recolored) images

2. manually recoloring lights

3. downloading a picture from which a color palette is extracted

In the embodiment of the mobile device 1 shown in FIG. 1, the mobile device 1 comprises one processor 5. In an alternative embodiment, the mobile device 1 comprises multiple processors. The processor 5 of the mobile device 1 may be a general-purpose processor, e.g. from Qualcomm or ARM-based, or an application-specific processor. The processor 5 of the mobile device 1 may run an Android or iOS operating system for example. The memory 7 may comprise one or more memory units. The memory 7 may comprise solid-state memory, for example. The memory 7 may be used to store an operating system, applications and application data, for example. The camera 8 may comprise a CCD or CMOS sensor, for example.

The transceiver 3 may use one or more wireless communication technologies such as Wi-Fi (IEEE 802.11) to communicate with the wireless LAN access point 17, for example. In an alternative embodiment, multiple transceivers are used instead of a single transceiver. In the embodiment shown in FIG. 1, a receiver and a transmitter have been combined into a transceiver 3. In an alternative embodiment, one or more separate receiver components and one or more separate transmitter components are used. The display 9 may comprise an LCD or OLED panel, for example. The display 9 may be a touch screen. The mobile device 1 may comprise other components typical for a mobile device such as a battery and a power connector. The invention may be implemented using a computer program running on one or more processors.

In the embodiment of FIG. 1, the system of the invention is a mobile device. In an alternative embodiment, the system of the invention is a different device, e.g. an Internet server.

A first embodiment of the method of the invention is shown in FIG. 2. A step 101 comprises sequentially, in each of sub steps 101₁, 101₂ to 101ₙ, turning on each of a plurality of sets of one or more light sources and capturing an image of a spatial area comprising the plurality of sets of one or more light sources. Each of the images captures a similar or same spatial area and comprises only one of the plurality of sets of one or more light sources in a turned-on state. A step 103 comprises combining the images into a combined image. The combined image comprises each of the plurality of sets of one or more light sources in a turned-on state.

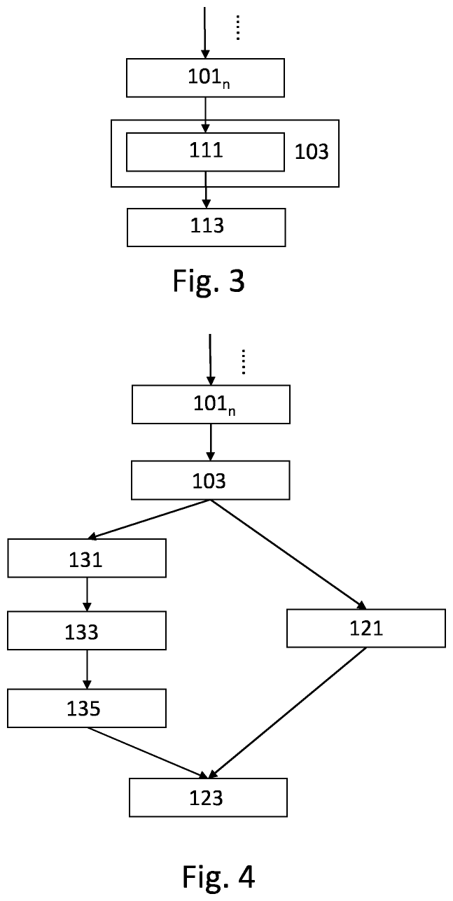

A second embodiment of the method of the invention is shown in FIG. 3. In this embodiment, step 103 comprises a sub step 111 of combining the images into a plurality of combined images. At least one of the sets of one or more light sources has a different color in a first one of the plurality of combined images compared to a second one of the plurality of combined images. The method further comprises a step 113 of allowing a user to scroll through the plurality of combined images and select one of the plurality of combined images to be used for controlling the colors of the light sources.

A third embodiment of the method of the invention is shown in FIG. 4. In this embodiment, the method further comprises a step 121 of allowing a user to adapt the combined image by manually recoloring one or more of the plurality of sets of one or more light sources in the combined image and a step 123 of rendering the adapted combined image to allow the user to see what the light system would look like in practice.

In the embodiment of FIG. 4, the method further comprises a step 131 of allowing a user to select a further image, a step 133 of extracting a color palette from the further image, and a step 135 of adapting the combined image by automatically recoloring one or more of the plurality of sets of one or more light sources in the combined image based on the determined color palette. The adapted combined image is rendered in step 123. In a variant on the embodiment of FIG. 4, step 121 is omitted or steps 131-135 are omitted.

In the embodiments of FIGS. 2-4, step 103 may comprise combining the images by including at least part of each of the images in one of a plurality of layers of the combined image and assembling the plurality of layers. This at least part of the image comprises a set of one or more light sources in a turned-on state. In this case, step 121 of FIG. 4 may comprise allowing a user to adjust each of the plurality of layers in brightness and/or chromaticity before assembling the plurality of layers. In step 123 of FIG. 4, the user may be presented with the option of exporting the combined layers as a photograph, effectively mimicking HDR photography.

In the embodiments of FIGS. 2-4, step 103 may comprise identifying pixels with a maximum color value in the images or in the combined image. The color value of the identified pixels may be replaced with another color value. When clipping occurs (e.g. pixels with max RGB values are detected), then this can occur for different reasons, each of which may merit a different response.

Clipping may occur when chromatic values (e.g. pure red) are sent to a lamp and the CCD sensor of the capture device cannot handle the resulting intensity or gamut.

Clipping may occur because the intensity is too high to capture in a default setting while the chromaticity is correct. This will typically occur when the native whitepoint of the capture device coincides with the Correlated Color Temperature (CCT) sent to the lamps. In sRGB devices this will typically occur when the CCT is 6500K.

If it is known which pixels correspond to the lights and their reflections and the color values sent to the light devices, clipped values can easily be replaced by the intended values. For example, lost chromatic information may be restored by taking edge pixel values into account and resetting the clipped values (i.e. the emitting surface of the lamp) to these edge pixel values. A gradient may be fitted over light source pixels where the center of the light source retains the clipped values in order to generate a more realistic appearance.

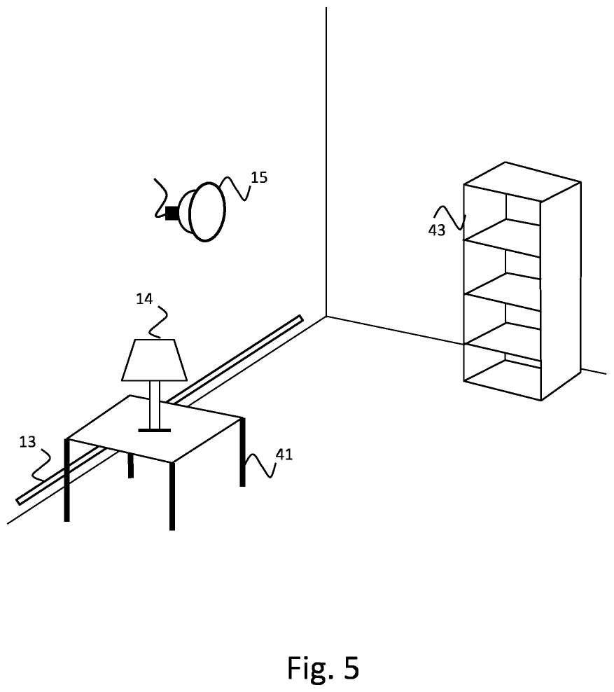

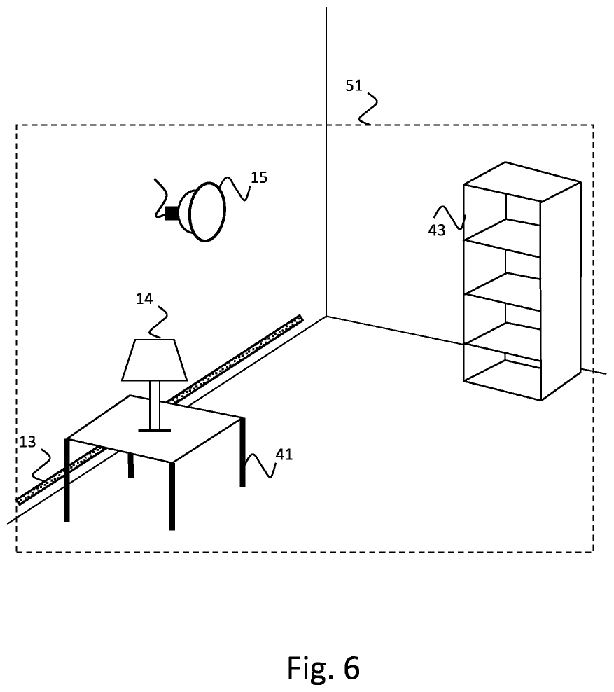

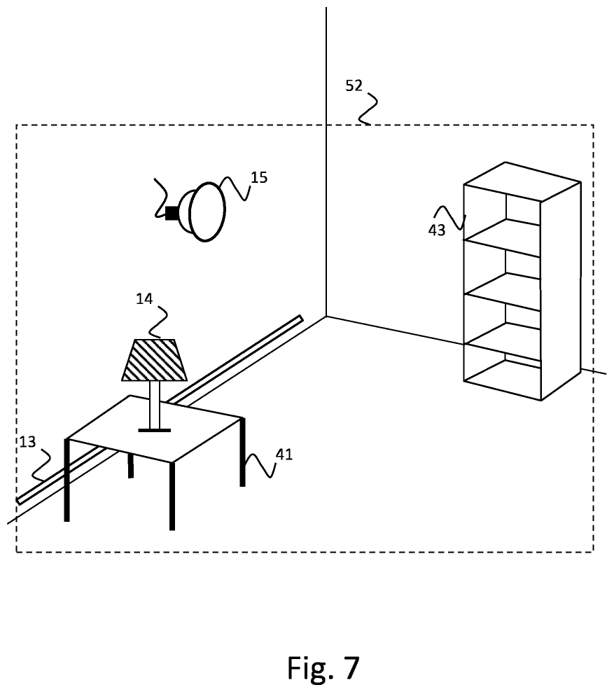

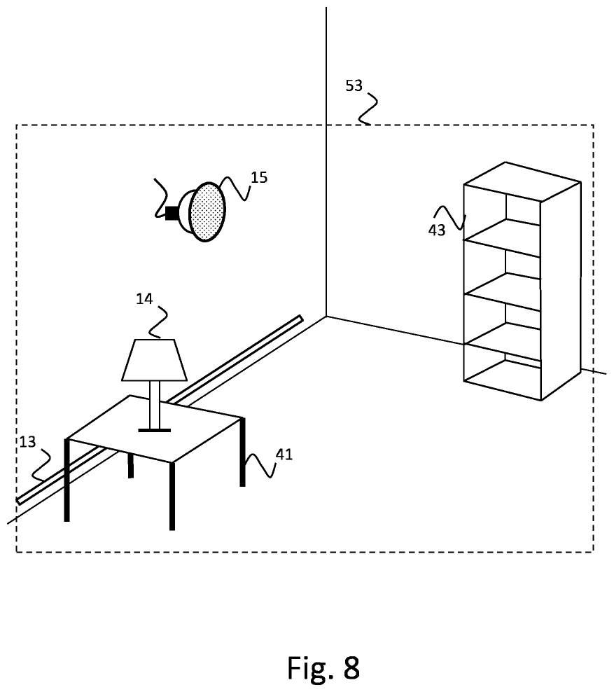

The method of FIGS. 2-4 are illustrated with the help of FIGS. 5 to 9. FIG. 5 depicts a room of a store with the three lights 13-15 of FIG. 1. Light 13 is a LED light strip illuminating the wall to which it is attached. Light 14 is a lamp standing on a table 41. Light 15 is a spotlight illuminating a cabinet 43. FIG. 6 shows the light 13 being switched on and the lights 14 and 15 being switched off while an image 51 is captured. FIG. 7 shows the light 14 being switched on and the lights 13 and 15 being switched off while an image 52 is captured. FIG. 8 shows the light 15 being switched on and the lights 13 and 14 being switched off while an image 53 is captured.

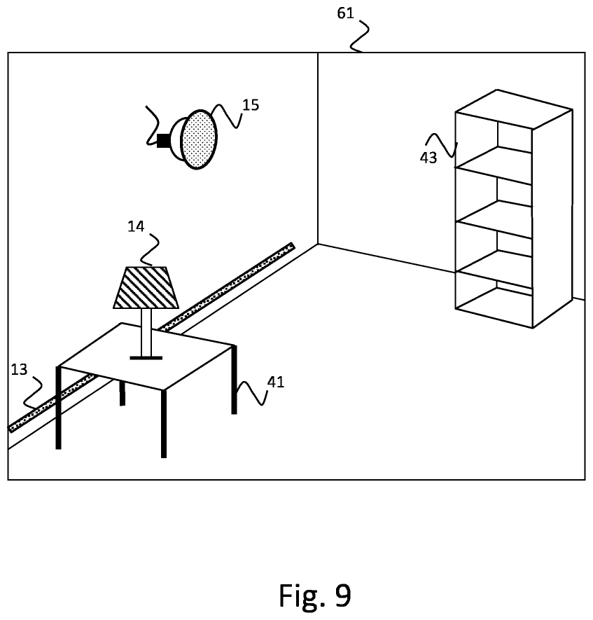

FIG. 9 depicts an example of an image which is a combination of images 51-53 of FIGS. 6-8. Each of images 51-53 is a rendering of the store with a specific light turned on, preferably stored as a layer. Typically, each image comprises information per set of one or more lights with respect to its or their position in the room and reflectance patterns of the lights (e.g. on the ceiling, walls and/or furniture). By combining these images, a faithful representation of their combined effect can be created. Before combining, the separate light layers may be adjusted in intensity or color resulting in a change in the light effect and reflectance's only in that light layer.

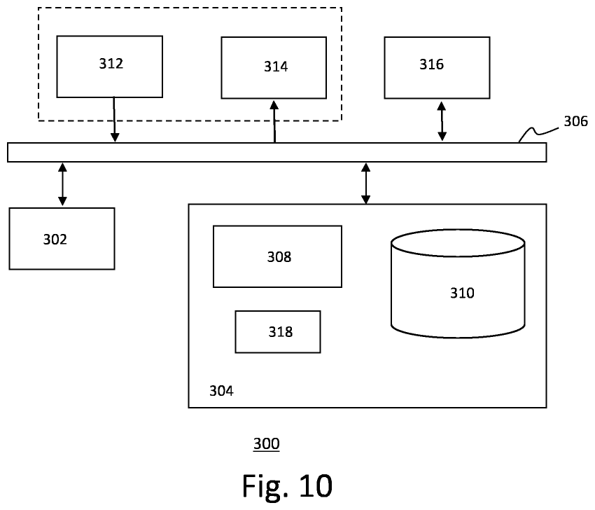

FIG. 10 depicts a block diagram illustrating an exemplary data processing system that may perform the method as described with reference to FIGS. 2-4.

As shown in FIG. 10, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that can perform the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution. The processing system 300 may also be able to use memory elements of another processing system, e.g. if the processing system 300 is part of a cloud-computing platform.

Input/output (I/O) devices depicted as an input device 312 and an output device 314 optionally can be coupled to the data processing system. Examples of input devices may include, but are not limited to, a keyboard, a pointing device such as a mouse, a microphone (e.g. for voice and/or speech recognition), or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 10 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 10, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 10) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. The embodiments were chosen and described in order to best explain the principles and some practical applications of the present invention, and to enable others of ordinary skill in the art to understand the present invention for various embodiments with various modifications as are suited to the particular use contemplated.

1. A system for capturing images, said system comprising at least one processor configured to:
sequentially turn on each of a plurality of sets of one or more light sources and capture an image of a spatial area comprising said plurality of sets of one or more light sources, each of said images capturing a similar or same spatial area and comprising only one of said plurality of sets of one or more light sources in a turned-on state, and
combine said images into a combined image, said combined image comprising each of said plurality of sets of one or more light sources in a turned-on state,
wherein said at least one processor is configured to combine said images into a plurality of combined images, at least one of said sets of one or more light sources having a different color in a first one of said plurality of combined images compared to a second one of said plurality of combined images, and allow a user to scroll through said plurality of combined images and select one of said plurality of combined images.

2. (canceled)

3. A system as claimed in claim 1, wherein said at least one processor is configured to allow a user to adapt said combined image by manually recoloring one or more of said plurality of sets of one or more light sources in said combined image and render said adapted combined image.

4. A system as claimed in claim 1, wherein said at least one processor is configured to allow a user to select a further image, extract a color palette from said further image, adapt said combined image by automatically recoloring one or more of said plurality of sets of one or more light sources in said combined image based on said determined color palette and render said adapted combined image.

5. A system as claimed in claim 1, wherein said at least one processor is configured to combine said images by including at least part of each of said images in one of a plurality of layers of said combined image and assembling said plurality of layers, said part of said image comprising a set of one or more light sources in a turned-on state.

6. A system as claimed in claim 5, wherein said at least one processor is configured to allow a user to adjust each of said plurality of layers in brightness and/or chromaticity before assembling said plurality of layers.

7. A system as claimed in claim 1, wherein said at least one processor is configured to identify pixels with a maximum color value in said images or in said combined image.

8. A system as claimed in claim 7, wherein said at least one processor is configured to replace said color value of said identified pixels with another color value.

9. A system as claimed in claim 1, wherein said at least one processor is configured to change the setting of the at least one of said sets of one or more light sources having a different color in a first one of said plurality of combined images compared to a second one of said plurality of combined images, to said different color.

10. A lighting system comprising the system of claim 1.

11. A method of capturing images, comprising
sequentially turning on each of a plurality of sets of one or more light sources and capturing an image of a spatial area comprising said plurality of sets of one or more light sources, each of said images capturing a similar or same spatial area and comprising only one of said plurality of sets of one or more light sources in a turned-on state; and
combining said images into a combined image, said combined image comprising each of said plurality of sets of one or more light sources in a turned-on state,
wherein combining said images comprises combining said images into a plurality of combined images, at least one of said sets of one or more light sources having a different color in a first one of said plurality of combined images compared to a second one of said plurality of combined images, and further comprising allowing a user to scroll through said plurality of combined images and select one of said plurality of combined images.

12. (canceled)

13. A method as claimed in claim 11, further comprising allowing a user to adapt said combined image by manually recoloring one or more of said plurality of sets of one or more light sources in said combined image and rendering said adapted combined image.

14. A method as claimed in claim 11, further comprising allowing a user to select a further image, extracting a color palette from said further image, adapting said combined image by automatically recoloring one or more of said plurality of sets of one or more light sources in said combined image based on said determined color palette and rendering said adapted combined image.

15. A computer program or suite of computer programs comprising at least one software code portion or a computer program product storing at least one software code portion, the software code portion, when run on a computer system, causing the computer system to execute the steps of the method of any of claim 11.
